(19) United States
(12) Patent Application Publication
(10) Pub. No.: US 2007/0264550 A1
(43) Pub. Date: Nov. 15, 2007

(54) AIR DIFFUSION CATHODES FOR FUEL CELLS

(75) Inventors: Lei Zhang, Richmond (CA); Hansan Liu, Vancouver (CA); Jiujun Zhang, Richmond (CA); Debabrata Ghosh, Vancouver (CA); Joey Chung Yen Jung, Vancouver (CA); Bruce Downing, White Rock (CA)

Correspondence Address: VERMETTE & CO., SUITE 320 - 1177 WEST HASTINGS STREET, VANCOUVER, BC, V6E2K3, CA

(73) Assignee: Magpower Systems Inc., Delta (CA)

(21) Appl. No.: 11/694,627

(22) Filed: Mar. 30, 2007

Related U.S. Application Data
(60) Provisional application No. 60/767,469, filed on Mar. 30, 2006.

(51) Int. Cl. H01M 4/00; B05D 5/12

(52) U.S. Cl. 429/27; 427/115

(57) ABSTRACT

An air-diffusion cathode and methods to make the same. The product and method comprise treating the metal substrate, applying multiple pastes containing catalyst, carbon powder, hydrophilic and hydrophobic property chemicals onto a metal substrate for cathodes in fuel cells, in which the metal substrate has a mesh or foam structure.

### RELATED APPLICATIONS

The present application is a replacement application of U.S. Provisional Patent Application No. 60/767,469 filed on Mar. 30, 2006.

### FIELD OF THE INVENTION

This invention relates generally to an air diffusion cathode for fuel cells and a process for fabrication thereof. More particularly, it relates to the improvement of the performance and commercial viability of fuel cells, in particular with respect to current density, internal resistance, corrosion resistance, durability, total material cost and manufacturing cost.

### BACKGROUND OF THE INVENTION

Fuel cells are devices that generate electricity through electrochemical reactions directly from the supplied fuels, and an oxidant like oxygen. Many fuels are used in fuel cells, such as hydrogen gas, natural gas, alcohol, or metal. Fuel cells are attractive power sources for primary and secondary power supplies because of their high specific energy, energy density and light weight.

Major components in a fuel cell include an anode (the fuel source), electrolyte, and air diffusion cathode. As is well known in the art, an air diffusion cathode is a sheet-like member having opposite faces exposed to two different environments, an atmosphere and an aqueous solution, or an atmosphere and a solid, respectively. It is generally recognized that an air diffusion cathode must form a three-phase (gas-solid-liquid) interface where gas, catalyst/carbon and electrolyte are in contact, so as to facilitate the reaction of gaseous oxygen. The atmospheric side needs to be permeable to air but substantially hydrophobic in order to avoid electrolyte leakage through the air diffusion cathode to the atmosphere boundary. The current collector embedded in the air diffusion cathode is necessary for current flow and structural support for the air diffusion cathode. During operation, oxygen passes through the air diffusion cathode and reduces to anion via an electrochemical reaction, with electrons flowing from external circuitry.

One type of fuel cell is a metal-air fuel cell. Metal-air fuel cells are an attractive power source for stand-alone power supplies (e.g. for stand-by or emergency power). They feature electrochemical coupling of a metal anode to an air diffusion cathode through a suitable electrolyte to produce a cell with an inexhaustible cathode reactant from the oxygen in atmosphere air.

The discharge reaction mechanism of a metal-air fuel cell is expected as follows if the cathode O₂ reduction is a four-electron process:

| | |
|---|---|
| Anode | Metal → Metal^{2+/3+} + 2e⁻/3e⁻, |
| Cathode | ½ O₂ + H₂O + 2e⁻ → 2OH⁻, |

However, despite the number of metal-air fuel cells developed to date, metal-air fuel cells still are not in common usage. One of the limiting factors is the difficulty in developing cost effective, simple, reliable cathode structures, which deliver high performance, optimize cathode catalyst recipe specifications, optimize cathode mass transport architecture structure, and allow economic manufacturing processes. For instance, current commercially developed air diffusion cathodes typically have problems of high cost, high internal electrical resistance, and susceptibility to corrosion of the current collector layer in alkaline or neutral electrolyte environments. Generally, prior air diffusion cathodes for metal-air fuel cells are made for alkaline electrolyte environments, which may not be suitable for neutral or salt (i.e. sodium chloride) electrolyte environments.

U.S. Pat. No. 4,885,217 (issued Dec. 5, 1989 to William H Hoge) discloses a two pass lamination method for fabrication of an air diffusion cathode, which is comprised of four layers: 1) a hydrophobic film layer facing the atmosphere environment, 2) a carbon sheet embedded with catalyst layer, 3) a metal mesh layer as current collector, and 4) a carbon sheet embedded with catalyst layer facing the electrolyte environment. This construction employs heat sealing of a coating material for binding the above-mentioned carbon and mesh layers together. The heat sealing method used to apply the hydrophobic film layer in the second pass produces highly inconsistent results in terms of air permeability through the cathode structure, which was evidenced by testing air diffusion cathode samples. As a result, this kind of structure suffers impaired performance, high cost and high internal electrical resistance. Furthermore, the metal current collector layer is exposed to the aqueous electrolyte environment, which will be corroded in the oxygen-rich environment, especially in a sodium chloride electrolyte environment. The corrosion of the metal current collector was evidence by the color of the electrolyte, which turned greenish during testing.

U.S. Pat. No. 6,368,751 B1 discloses an air diffusion cathode constructed by applying multiple pastes onto a porous metal foam. The cathode comprises a hydrophobic layer facing the atmosphere environment, a first catalyst embedded layer, a metal foam layer, and a second catalyst embedded layer facing the electrolyte environment. The metal foam is exposed to the aqueous electrolyte environment and therefore is susceptible to corrosion; especially in a sodium chloride electrolyte environment. Corrosion of the metal foam was evidenced by the electrolyte color becoming greenish after long term testing.

U.S. Pat. No. 6,835,489 B2 discloses an air diffusion cathode that is constructed with two mesh current collectors sandwiching a hydrophobic paste layer and a catalyst paste layer. One mesh current collector has one side contacting the hydrophobic paste and the other side facing the oxygen environment. Another mesh current collector has one side contacting the catalyst paste and the other side facing the aqueous electrolyte. The current collector, having one side facing the aqueous electrolyte, is subject to corrosion, especially in a sodium chloride electrolyte environment.

U.S. patent application Ser. No. 11/092,738 (filed Mar. 30, 2005 by Chen) discloses an air diffusion cathode that is constructed with at least a layer of current collector, two sintered diffusion layers, and a sintered activation layer. The air diffusion cathode is intended to be used in fuel cells or electric capacitors, particularly zinc-air fuel cells with an isolating membrane, potassium hydroxide or polymer electrolyte. The air diffusion cathode has two or more sintered diffusion layers to prevent water/electrolyte loss from the zinc-air fuel cell. Air diffusion cathodes having multiple sintered diffusion layers (i.e. two or more) suffer from complex manufacturing processes and high manufacturing costs.

The above prior art suffers from the following limitations: susceptibility to corrosion in acid or neutral electrolyte environments, high internal electrical resistance in part due to multilayer configuration, high material costs and manufacturing costs due to multilayer manufacture processes, uneven distribution of catalyst over the cathode structure due to direct deposit into the current collector.

The air diffusion cathodes disclosed in the prior art are constructed by sandwiching together multiple layers by adhering, heat sealing, or sintering. These multiple layers include hydrophobic layer, current collector, and catalyst layers, often separated by adhesive or sealing component. Each of the layers is a stand alone element or structure (e.g. in the form of a sheet or web) that must be prepared separately and in advance. Each such layer is then independently applied to the current collector. As a result, the prior art discloses air diffusion cathodes, and method for the manufacture thereof, that are unnecessarily complex and that suffer from the disadvantages described above.

A need exists for an air diffusion cathode that is fabricated with cost effective materials along with a cost-effective, continuous manufacturing process, and which cathode can resist corrosion and has adequate performance for fuel cells.

### SUMMARY OF THE INVENTION

The present invention relates to air diffusion cathodes for fuel cells, and methods for the manufacture thereof. More specifically, the present invention provides a simplified air diffusion cathode that exhibits improved performance and corrosion resistance. The present invention involves the application of hydrophobic paste and catalyst enriched paste/ink directly onto a current collector, the current collector providing a support structure for hydrophobic paste and catalyst paste/ink.

According to an aspect of the present invention, the air diffusion cathode includes a mesh, net or foam substrate acting as a current collector and having a mesh or an open foam structure.

In another aspect of the present invention, the current collector undergoes treatment in an acidic environment to cause etching to increase its surface area, followed by water rinsing to remove residual acid, then drying, and finally coating.

In another aspect of the present invention, the current collector of the air diffusion cathode is deposited with a hydrophobic paste to form a gas diffusion layer on the current collector. The hydrophobic paste is comprised of carbon powder and hydrophobic materials such as polytetrafluoroethylene (PTFE). The hydrophobic paste fills up the open pores of the current collector and covers the faces of the current collector.

In an alternative embodiment of the present invention, one side of the current collector face is deposited with a first hydrophobic paste comprising carbon powder and hydrophobic property chemicals with a specific thickness and material loading to form a first gas diffusion layer. The other side of the current collector is deposited with a second hydrophobic paste with a different recipe and with a specific thickness and material loading to form a second gas diffusion sub-layer on the current collector. The first and second hydrophobic pastes have different hydrophobic properties and electrical conductivities.

In another aspect of the present invention, one side of the paste-filled current collector is deposited with a specific thickness and material loading of a catalyst embedded paste or ink, containing catalyst, carbon powder, hydrophilic property chemicals, and hydrophobic property chemicals. The catalyst enriched paste may have different viscosity and/or composition compared to a catalyst enriched ink. The catalyst embedded paste or ink has the properties of being simultaneously hydrophobic and hydrophilic. The catalyst paste is deposited on the side of the cathode facing the electrolyte.

In the other aspect of the present invention, a method is provided for forming an air diffusion cathode for an electrochemical cell. The method includes the steps of:
providing a current collector having a mesh or a foam structure;
treating the current collector in acidic environment followed by acid removal via water rinsing, and drying
applying and curing one or more hydrophobic pastes within the open pores and onto the faces of the current collector; and
applying and curing a catalyst enriched paste or ink over the hydrophobic paste on one side of the current collector.

The present invention creates an air diffusion cathode for fuel cells, having a monolithic structure in that it does not require any adhesive, sealing or bonding material between the current collector and the GDL paste, or between the GDL paste and the catalyst enriched paste/ink. The monolithic structure results in lower internal electrical resistance and a more economical manufacturing process. The monolithic structure contains a gas permeable hydrophobic layer (GDL) in direct contact with the current collector. The current collector provides a structure to support the gas permeable hydrophobic layer (GDL). The gas permeable hydrophobic layer and the current collector in turn provide support for the catalyst paste/ink layer. With the support, the catalyst can be evenly distributed, which provides uniform and improved performance of the cathode.

The above and other features and advantages of the present invention will be readily apparent from the following detailed description of various aspects of the present invention taken in conjunction with the accompanying drawings.

### BRIEF DESCRIPTION OF THE DRAWINGS

FIG. 1 is a schematic view of a fabrication process of the air diffusion cathode according to a first embodiment of this invention.

FIG. 2 is a schematic view of a fabrication process of the air diffusion cathode according to a second embodiment of this invention.

FIG. 3 is a performance comparative graph between the present invention (Sample 2) and a fuel cell according to U.S. Pat. No. 4,885,217 (Sample 1).

### DETAILED DESCRIPTION OF THE PREFERRED EMBODIMENTS

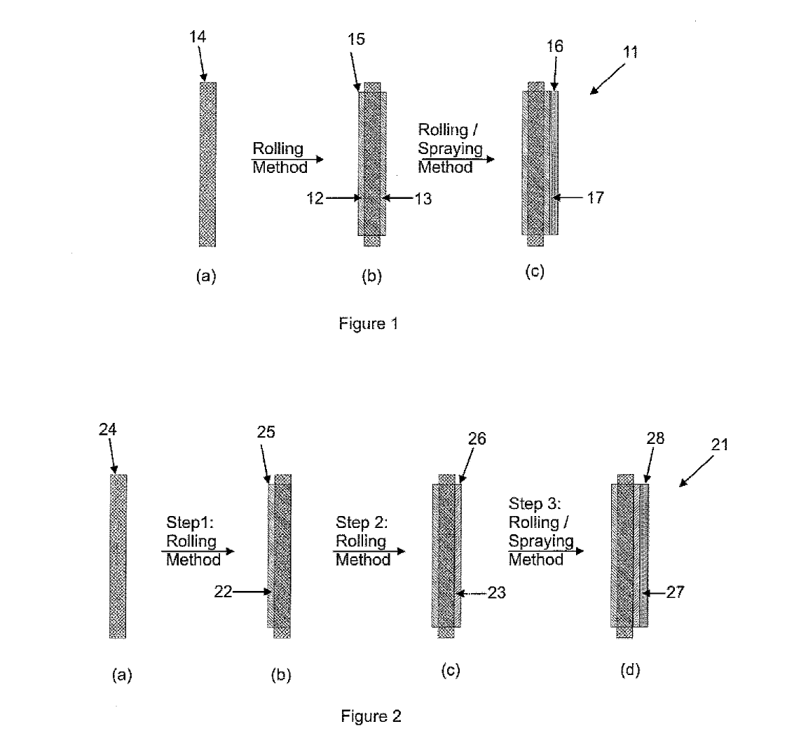

FIG. 1 represents the fabrication process of the air diffusion cathode according to a first embodiment of this invention. The air diffusion cathode 11 includes a metal mesh or foam substrate 14, with a hydrophobic and air permeable paste deposited on it to form a gas diffusion layer 15. The gas diffusion paste fills up the open spaces in the substrate 14 and covers faces 12 and 13 at desired thicknesses and material loadings. A catalyst paste or ink, which is simultaneously hydrophobic and hydrophilic, is subsequently deposited onto face 17 to form a catalyst sub-layer 16 with a desired thickness and material loading.

FIG. 1 (a) shows a metal mesh, net or foam substrate 14, which acts as a current collector. The metal current collector is subject to immersion in an acid bath to incur a surface treatment to increase surface area and to remove surface impurities such as grease or dust that may be on the metal current collector. The acid bath is preferably followed by water rinsing, washing, and drying. One example of an acid that can be used is 15 weight percent (wt %) hydrochloric acid (HCl), that can be prepared using 37 wt % HCl from Sigma Aldrich The metal or foam substrate 14 is formed of a suitable metallic material, such as nickel, stainless steel, silver coated copper, and the like. An example of a suitable substrate material is a nickel metal mesh, designated 4 Ni 10-125, from Dexmet Corp.

As shown in FIG. 1 (b), a hydrophobic and air permeable paste was deposited into the metal mesh or foam to form a gas diffusion layer (GDL) 15. The paste for the GDL 15 includes carbon particles and Teflon®, which are mixed uniformly before being applied to the substrate 14. The Teflon® preferably comprises about 30 to 80 wt % of the blend. In one specific embodiment the hydrophobic and air permeable paste contained 70 weight % carbon powder and 30 weight % of PTFE powder. An example of the Teflon® which can be used is the 60 wt % aqueous dispersion Teflon® solution from Sigma-Aldrich. The GDL sub-layer is simultaneously hydrophobic and air permeable. Teflon® here also acts as a binder for bonding the GDL paste onto the substrate.

The rolling method, a widely used and relatively inexpensive method used in the manufacture of air diffusion cathodes, can be used to extrude the paste onto the metal mesh. In a laboratory setting, the rolling was followed by a heat press with pressure ranging from about 200 to 1000 lbs/cm² in order to cure the GDL and catalyst layers. The heat press involved a two-step temperature sequence, a first step at from 20° C. to 100° C., and a second step at from 200° C. to 800° C., to form a uniform, flexible, and crack-free coating on the current collector which is air permeable. The loading of the GDL paste may be in the range of about 0.02 to 0.5 g/cm². The GDL 15 acts to prevent electrolyte leakage, serves as an air channel, protects the metal mesh 14 from corrosion, and acts as a support for the catalyst layer 16. With CDL acting as a support, the catalyst paste/ink can be deposited with even distribution compares to some prior arts that deposited the catalyst direct into the current collector.

A catalyst enriched paste or ink is deposited onto one side of the GDL 15 to form a catalyst layer 16 as shown in FIG. 1 (c). The loading of the catalyst paste or ink may be in the range of about 0.01 to 0.5 g/cm². The catalyst layer 16 contains catalyst, carbon, hydrophilic property chemical like Nafion®, and hydrophobic property chemical like Teflon®. The catalyst, carbon, Nafion®, and Teflon may comprise about 3 to 60 wt %, 50 to 95 wt %, 1 to 10 wt %, and 20-65 wt % of the catalyst enriched paste or ink, respectively. The catalyst is selected from the group consisting of cobalt tetra-methoxyphenylphorphyrin (CoTMPP), iron tetramethoxyphenylphorphyrin (FeTMPP), pyrolyzed CoTMPP, pyrolyzed FeTMPP, platinum, and combinations thereof. An example is CoTMPP available from Sigma Aldrich. Carbon acts as a support for the catalyst and an electric conductor. An example of the carbon used is black pearl 2000 powder from Cabot Corp. Nafion®, for example, from Sigma Aldrich, has hydrophilic properties which promote electrolyte interaction with oxygen from air at the catalyst surface. Teflon®, for example 60 wt % aqueous dispersion Teflon® solution from Sigma Aldrich, acts as both a hydrophobic agent and a binder. One of the methods for depositing the catalyst paste or ink onto one side of the GDL 15 to make the catalyst layer 16, is through a spray method, such as is extensively employed in the fabrication of membrane electrode assemblies (MEA's) for proton exchange membrane fuel cells (PEMFC). The spray method has the advantages of making a uniform, stable catalyst layer 16 with high utilization.

A catalyst enriched ink and paste can have different compositions. In one specific embodiment the catalyst ink used contained 77 weight % catalysed carbon powder and 23 weight % Nafion®. The catalyst enriched paste might have, for example, a composition of 60% catalysed carbon powder, 35% of GDL paste (70 weight % of carbon powder and 30 weight % of PTFE powder), and 5% Nafion®.

In certain embodiments of the invention it may be possible to substitute one or more of the following compounds for Nafion®: S-PEEK (Sulfonated polyetheretherketon); S-PPO (Sulfonated polyphenylene oxide); S-PSF (Sulfonated polysulfone); S-PPBP (Sulfonated poly (4-phenoxybenzoyl-1,4-phenylene); S-PPS (Sulfonated polyphenylenesulfide); S-PBI (Sulfonated polybenzimidazole); and S-PI (Sulfonated polyimide).

The rolling process (sometimes referred to as a pasting process) is a well known technique in battery manufacture industry. For example, the pasting process can be done by a modified orifice paster, such as is manufactured by MAC Engineeing and Equipment Company Inc., located in Michigan, USA.

The spraying process is a well known technique in the fuel cell industry. The spraying step of the present invention can be done by an automated spray system from EFD Inc. of Rhode Island, USA, for example.

The deposition of the layers in the specific embodiment described above involves a curing process of two press steps when applying GDL paste and catalyst paste/ink onto the current collector. The two press steps occur at different temperatures; a “cold” press (i.e. approx. room temperature press (20° C.-100° C.) after application of the GDL paste, and a “high” temperature press (approx. 200° C.-800° C.) after application of the catalyst paste or ink). The cold press was required in the laboratory setting due to the fact that the pastes were not applied with sufficient force to properly coat the current collector and force the paste into the current collector. The cold press step will likely be eliminated when the manufacturing process is scaled up to industrial scale, since the paste will be applied to the current collector with greater force. In such instances, a “one-stage” pressing is all that is required (i.e. pressing within a single temperature range).

In general terms, the method described above includes the steps of:
1 providing a current collector having a mesh or a foam structure;
2. applying and curing one or more hydrophobic pastes within the open pores and onto the faces of the current collector; and
3. applying and curing a catalyst enriched paste or ink over the hydrophobic paste on one side of the current collector.

The deposition of each of the hydrophobic pastes and catalyst enriched paste (or ink) involves a curing step (i.e. deposition involves application and curing). In the laboratory setting the best results were achieved when the method was carried out in this manner. However, it is believed that when the method is scaled up to industrial scale it may be possible to combine one or more of the steps. For example, the application and/or curing of the hydrophobic and catalyst pastes may be combined so that they are essentially applied simultaneously. Alternatively, or in addition, the curing steps may be combined into one curing step.

The direct deposition of a catalyst layer 16 onto the GDL 15 here replaces the complex process of impregnating a web of carbon fibers with a slurry containing carbon particles, catalyst, dispersing agent, flow control agent and binder, as used in the prior art cathode fabrication practice (e.g. as disclosed in U.S. Pat. No. 4,885,217). The catalyst layer 16 can provide a hydrophilic active reaction surface which makes a web of carbon fibers unnecessary, and also reduces the cost significantly. The present invention results in a continuous, monolithic coating or structure deposited directly onto the surface of the current collector. Since both the GDL 15 and catalyst layer 16 are directly deposited onto the current collector, a heat seal coating material as used in the prior art, for bonding the current collector to the adjacent layer, is no longer needed. The absence of such heat seal coating decreases the internal electrical resistance and gas flow restriction of the system and, therefore, increases air permeability and water transportation to the reaction sites. By using an integrated structure air diffusion cathode, the present invention is more cost effective in terms of materials and manufacture costs.

The continuous, monolithic structure of the present invention, and the method of manufacture, exhibit decreased material costs, number and complexity of system components, internal electrical resistance, and gas flow restriction, while providing improved corrosion resistance of the current collector in alkaline or neutral electrolyte environments.

FIG. 2 represents the fabrication process of the air diffusion cathode according to an alternative embodiment of this invention. The air diffusion cathode 21 includes a metal mesh, foam or net substrate 24, with a hydrophobic and air permeable paste deposited thereon to form a first gas diffusion layer 25 (GDL). The gas diffusion paste fills up the substrate 24 and covers face 22 at a specific desired thickness and material loading. For example, the loading may be in the range of about 0.02 to 0.5 g/cm². Another hydrophobic and air diffusion paste with a different chemical recipe (i.e. different proportions, as measured by wt %, of the constituent materials), is deposited onto the face 23 to form a second gas diffusion layer 26 with a specific thickness and material loading (about 0.01 to 0.5 g/cm²). A catalyst paste or ink, which is simultaneously hydrophobic and hydrophilic, is deposited onto face 27 to form a catalyst layer 28 with a specific thickness and material loading (e.g. about 0.01 to 0.5 g/cm²).

### COMPARATIVE EXAMPLE 1

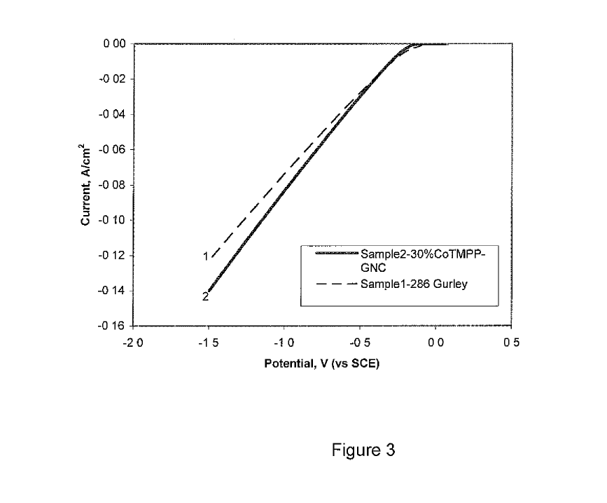

FIG. 3 shows the performance comparison of two air diffusion cathodes:
(a) an embodiment of U.S. Pat. No. 4,885,217 (Sample 1); and
(b) an embodiment of the present invention (Sample 2).

Linear sweeping voltammetry (LSV) was used to record the performance of the samples with respect to oxygen reduction (OR). Theoretically, the OR kinetic of an air (gas) diffusion cathode is limited mainly by catalyst activity at the low current densities and by gas diffusion rates at the high current densities LSV curves obtained at different potential ranges directly give information on the catalyst activity and air permeability of the air diffusion cathodes. The experiments were conducted using a Solartron 1480 multi-potentiostat. The electrolyte was a 10 wt % sodium chloride (NaCl) solution. The sweeping potential range was set from 0 V to −1.5V (vs. SCE) with a potential scan rate of 20 mV/s. As shown in FIG. 3, sample 2—GNC (its structure is Gas Diffusion layer/Nickel mesh/Catalyst layer, where the catalyst layer is a catalyst ink (77 weight % catalysed carbon powder and 23 weight % Nafion®) and the GDL is 70 weight % carbon powder and 30 weight % of PTFE powder) can give a performance better than that of commercially available air diffusion cathodes equipped with COTMPP catalyst from Fuel Cell Technology Inc (Sample 1-286-Gurley, as listed in Table 1) At potentials lower than −0.5V, the current density of Sample 2 increases with potential at a faster rate than that of Sample 1, which indicates that sample 2 may have better air permeability than sample 1. Moreover, the current density of Sample 2 at −1.5V is 140 mA/cm² which is the highest one among experimental samples. The results show that the air diffusion cathode of the present invention (Sample 2) is comparable to, or better than, Fuel Cell Technology's commercially available air diffusion cathode in terms of catalyst activity.

TABLE 1
Current densities of air diffusion cathodes at
various potential (vs. SCE) at 22° C.

| | Current density (mA/cm²) | | | |
|---|---|---|---|---|
| Sample | −0.25 V | −0.5 V | −1.0 V | −1.5 V |
| Sample 1-286-Gurley | 8 | 27 | 73 | 123 |
| Sample 2-GNC | 6 | 29 | 83 | 140 |

### EXAMPLE 2 COMPARISON OF MAXIMUM CURRENT DENSITY OF ONE EMBODIMENT OF THE PRESENT INVENTION WITH COMMERCIAL AVAILABLE AIR DIFFUSION CATHODES

Table 2 shows a performance comparison between three embodiments of the present invention and a number of commercially available air diffusion cathodes from various manufacturers. Each of the three embodiments includes a different catalyst, however, the GDL and catalyst layers are the same (catalyst ink (77 weight % catalysed carbon powder and 23 weight % Nafion®) and GDL (70 weight % carbon powder and 30 weight % of PTFE powder)).

Linear sweeping voltammetry (LSV) was used to record the maximum current density of each air diffusion cathode samples. The experiments were conducted using a Solartron 1480 multi-potentiostat. The electrolyte was a 10 wt % sodium chloride (NaCl) solution. The sweeping potential range was set from 0 V to −1.5V (vs. SCE) with a potential scan rate of 20 mV/s. As shown in Table 2, the performance of the present invention essentially matches the performance of an air diffusion cathode sample 111705 from Evionyx, and outperforms the rest of the air diffusion cathode samples. However, the cost of the air diffusion cathode from Evionyx is significantly higher than that of the present invention due to the fact that its current collector is a nickel foam.

TABLE 2
Performance comparison of one embodiment of the present invention
with commercially available air-cathodes at room temperature in 10
wt % NaCl solution; measured unit in mA/cm² @ −1.5 V

| | | | Current |
|---|---|---|---|
| | | Catalyst | Density |
| Sample & Manufacturer | Layers | Type | (maximum) |
| Evionyx 0805 | T-M | | 117 |
| Evionyx 111705 | T-F | | 129 |
| Yardney Technical | T-C-M-C | spinel | 115 |
| AC71 | | | |
| Yardney Technical | T-C-M-C | Ag | 106 |
| AC65-1219 | | | |
| Fuel Cell | T-C-M-C | Mn | 110 |
| Technologies | | | |
| FC51 Batch 79 | | | |
| Fuel Cell | T-C-M-C | spinel | 117 |
| Technologies | | | |
| FC71 Batch 79 | | | |
| Fuel Cell | T-C-M-C | CoTMPP | 118 |
| Technologies | | | |
| FC75 Batch 88 | | | |
| Gaskatel 271 | T-M | | 110 |
| Gaskatel 279 | T-M | Co Porphyrin | 122 |
| Dopp | T-M | Mn | 89 |
| E4A | T-C-M | Mn | 98 |
| E4A with Separator | T-C-M-S | Mn | 94 |
| E4 | T-C-M | Mn | 109 |
| E4 with Separator | T-C-M-S | Mn | 99 |
| E5 | T-C-M | CoTMPP | 114 |
| SN95/6A/75/Ex | T-CM | Ag | 115 |
| An embodiment of | M | Co Porphyrin | 128 |
| present invention | | | |
| Second embodiment of | M | Co/Fe Porphyrin | 129 |
| present invention | | | |
| Third embodiment of | M | Fe Porphyrin | 122 |
| present invention | | | |

T: Teflon ®, C: Carbon, M: Mesh, F: Foam

The structures of the commercially available air diffusion cathodes expose the current collectors to the electrolyte, whereas the current collector of the present invention is protected by the GDL layer. In the structure of the commercially available cathodes the catalyst containing paste is deposited directly onto the bare metal current collector, which allows electrolyte to contact the current collector. In a neutral pH electrolyte like 10 wt % NaCl, the current collector is therefore subject to significant corrosion no matter whether the material is nickel or stainless steel, thus significantly reducing the effective life span of the air diffusion cathode. The corrosion of the current collectors of the commercial available air diffusion cathodes in 10 wt % NaCl electrolyte was evidenced in the above tests by the color of the electrolytes turning darker during testing, (especially from the samples with nickel mesh or nickel foam as current collector material). The present invention advantageously exhibits improved corrosion resistance in neutral electrolyte environments due to the hydrophobic layer covering the current collector, which prevents electrolyte contact with the current collector and the resulting detrimental corrosion.

1. A monolithic air diffusion cathode for fuel cells, comprising;
a. a current collector;
b. at least one hydrophobic and air permeable paste deposited onto said current collector to form a gas diffusion layer;
c. one of a catalyst enriched paste and a catalyst enriched ink deposited onto said gas diffusion layer on one side of said current collector to form a catalyst layer.

2. The air diffusion cathode of claim 1, wherein said current collector is pretreated in an acidic environment, rinsed and dried.

3. The air diffusion cathode of claim 1, wherein said hydrophobic and air permeable paste contains carbon particles.

4. The air diffusion cathode of claim 1, wherein said hydrophobic and air permeable paste contains polytetrafluoroethylene (PTFE).

5. The air diffusion cathode of claim 1, wherein said catalyst layer contains carbon particles and catalyzed carbon particles.

6. The air diffusion cathode of claim 1, wherein said catalyst layer contains polytetrafluoroethylene (PTFE) and Perfluorosulfonic acid.

7. The air diffusion cathode of claim 1, wherein said catalyst layer contains about 3 to 60 wt % catalyst, 50 to 95 wt % carbon, 1 to 10 wt % Nafion, and 20-65 wt % PTFE.

8. The air diffusion cathode of claim 1, wherein said catalyst layer contains one or more catalysts selected from the group consisting of cobalt tetramethoxyphenylphorphyrin (CoTMPP), iron tetramethoxyphenylphorphyrin (FeTMPP), pyrolyzed CoTMPP pyrolyzed FeTMPP, platinum and nickel porphyrine.

9. The air diffusion cathode of claim 1, wherein said current collector comprises at least one of nickel, stainless steel, titanium, silver and silver-coated copper.

10. The air diffusion cathode of claim 1, wherein said gas diffusion layer comprises a first hydrophobic and air permeable paste deposited onto a first side of said current collector and a second hydrophobic and air permeable paste deposited onto a second side of said current collector.

11. The air diffusion cathode of claim 1, wherein a loading of said hydrophobic and air permeable paste is in a range of about 0.01 to 0.5 g/cm² and a loading of said the catalyst paste or said catalyst ink is in a range of about 0.01 to 0.5 g/cm².

12. A method of making an air diffusion cathode for a fuel cell, comprising:
a. providing a current collector having a mesh or a foam structure;
b. depositing one or more hydrophobic and air permeable pastes onto said current collector to form a gas diffusion layer; and
c. depositing a catalyst enriched paste or ink over said gas diffusion layer on one side of said current collector to form a catalyst layer.

13. The method of claim 12, wherein said current collector is treated in an acidic environment, rinsed and dried, prior to said depositing of said hydrophobic and air permeable paste.

14. The method of claim 12, wherein said hydrophobic and air permeable paste contains carbon particles.

15. The method of claim 12, wherein said hydrophobic and air permeable paste contains polytetrafluoroethylene (PTFE).

16. The method of claim 12, wherein said catalyst layer contains carbon particles and catalyzed carbon particles.

17. The method of claim 12, wherein said catalyst layer contains polytetrafluoroethylene (PTFE) and Perfluorosulfonic acid.

18. The method of claim 12, wherein said catalyst layer contains about 3 to 60 wt % catalyst, 50 to 95 wt % carbon, 1 to 10 wt % Nafion, and 20-65 wt % PTFE.

19. The method of claim 12, wherein said catalyst layer contains one or more catalysts selected from the group consisting of cobalt tetramethoxyphenylphorphyrin (CoTMPP), iron tetramethoxyphenylphorphyrin (FeTMPP), pyrolyzed CoTMPP pyrolyzed FeTMPP, platinum and nickel porphyrine.

20. The method of claim 12, wherein said current collector comprises at least one of nickel, stainless steel, titanium, silver and silver-coated copper.

21. The method of claim 12, wherein said hydrophobic and air permeable paste is subjected to a two-step heat press, wherein a first step is at a temperature of about 20 to 100° C. and a second step is at a temperature of about 200 to 800° C., with pressure ranging from about 200 to 1000 lbs/cm².

22. The method of claim 12, wherein said gas diffusion layer comprises a first hydrophobic and air permeable paste deposited onto a first side of said current collector and a second hydrophobic and air permeable paste deposited onto a second side of said current collector.

23. The method of claim 12, wherein a loading of said hydrophobic and air permeable paste is in a range of about 0.01 to 0.5 g/cm² and a loading of said the catalyst paste or said catalyst ink is in a range of about 0.01 to 0.5 g/cm².
